(19) United States
(12) Patent Application Publication
(10) Pub. No.: US 2014/0147728 A1
(43) Pub. Date: May 29, 2014

(54) BATTERY CELL CONNECTOR, METHOD FOR PRODUCING A BATTERY CELL CONNECTOR, BATTERY, BATTERY SYSTEM, AND MOTOR VEHICLE

(71) Applicants: Alexander Reitzle, Neu-Ulm (DE); Conrad Bubeck, Esslingen (DE)

(72) Inventors: Alexander Reitzle, Neu-Ulm (DE); Conrad Bubeck, Esslingen (DE)

(73) Assignees: Samsung SDI Co., Ltd., Yongin-si Gyeonggi-do (KR); Robert Bosch Gmbh, Stuttgart (DE)

(21) Appl. No.: 13/806,611

(22) PCT Filed: May 2, 2011
(86) PCT No.: PCT/EP11/56921

§ 371 Date: Apr. 18, 2013

(30) Foreign Application Priority Data
Jul. 2, 2010 (JP) 2010-151875

(51) Int. Cl. H01M 2/20; H01R 43/00; H01M 2/22

(52) U.S. Cl. CPC H01M 2/202; H01M 2/22; H01R 43/00
USPC 429/158; 29/874

(57) ABSTRACT

A connector is configured to produce an electrically conductive connection between battery cell terminals, in particular between battery cell terminals of multiple battery cells in order to electrically link said battery cells. The connector comprises at least two connecting sections, each of which is composed of a different material and which are connected to each other in an electrically conductive manner in at least one connecting region by mutually contacting surfaces. The surfaces of both connecting sections lie against each other, and particles of the surfaces of both connecting sections are mixed in a boundary layer.

The present invention relates to a connector for producing an electrically conductive connection between battery cell terminals, in particular between battery cell terminals of a plurality of battery cells, in order to electrically link said battery cells, wherein the connector comprises at least two connecting portions, each of which comprises a different material and which connecting portions are mutually connected in an electrically conductive manner in at least one connecting region by means of mutually contacting surfaces.

In addition, the present invention relates to a method for producing a connector in accordance with the invention, and a battery, in particular a lithium-ion battery or a nickel metal-hydride battery, that comprises at least one connector in accordance with the invention, and a battery system that comprises a plurality of batteries, in particular lithium-ion batteries or nickel metal-hydride batteries, and at least one connector in accordance with the invention. The present invention also relates to a motor vehicle, in particular a motor vehicle that can be driven by an electric motor, which motor vehicle comprises at least one battery in accordance with the invention or comprises a battery system in accordance with the invention.

A battery that comprises one or a plurality of galvanic battery cells is used as an electro-chemical energy storage device and energy converter. As the battery and/or the respective battery cell is/are being discharged, chemical energy that is stored in the battery is converted into electrical energy by means of an electro-chemical Redox reaction. This electric energy can thus be requested by a user as needed.

Lithium-ion batteries or nickel metal-hydride batteries that comprise a large number of electro-chemical cells that are connected in series are used in so-called battery packs in particular in hybrid and electric vehicles. In this case, a battery management system including a battery state detection system is conventionally used to monitor the reliability and to ensure a longest possible serviceable life.

### PRIOR ART

It is known to mutually fixedly connect terminals or poles of batteries and/or battery cells in order to produce a series connection or a parallel connection.

Diverse methods are known for producing this fixed connection, in particular for producing connections of different metallic materials. It is, for example, possible to produce a non-releasable connection of different metal materials, for example, by means of roll plating.

DE 10 2008 018 204 A1 discloses a composite material that is produced by means of cold-roll plating. This composite material comprises a low-alloyed steel material, an intermediate layer that is embodied from a copper or nickel material and a layer that is embodied from a high-alloyed steel material. Composite materials of this type have the advantage of relatively low costs owing to low-alloyed steel being used in conjunction with alternative material properties owing to high-alloyed steel being used.

However, owing to the conventionally relatively high number of pieces, a welding method, such as laser welding, is used to connect terminals and/or poles of battery cells. A disadvantage in this case is the fact that, owing to the different material of the terminals and/or the battery cell poles that conventionally comprise materials that comprise copper and materials that comprise aluminum and as a consequence have different melting points, technical problems arise that can only be overcome with a relatively high expenditure.

A further problem when connecting materials that comprise copper and materials that comprise aluminum in order to connect battery cell poles and/or battery cell terminals is the susceptibility to corrosion. The two different materials together form an electro-chemical voltage potential that causes corrosion. The corrosion is possibly increased by virtue of the fact that in the case of batteries and/or battery systems that are used, for example, to drive motor vehicles, condensation water is possibly formed owing to different temperature conditions in the battery system and said condensation water acts as a so-called electro-chemical local element when wetting the connection site between the material comprising copper and the material comprising aluminum. Ions are transported through the condensation water and the electrons are transported through the solid matter of the materials. In the case of a corrosion process of this type, the more base metal is dissolved and the more noble metal remains unchanged. The corrosion conventionally causes an increase in the transition resistance between the two materials by forming oxidic deposits and in the worst case scenario premature ageing and even to the failure of the battery system.

### DISCLOSURE OF THE INVENTION

In order to solve this problem, a connector is provided in accordance with the invention for producing an electrically conductive connection between battery cell terminals, which connector can be used in particular between battery cell terminals of a plurality of battery cells in order to electrically link these battery cells. This connector comprises at least two connecting portions, each of which is embodied from a different material and which connecting portions are mutually connected in an electrically conductive manner in at least one connecting region by means of mutually contacting surfaces. The connection of the two connecting portions is achieved in this case in such a manner that particulate materials of the surfaces of the two connecting portions, which surfaces lie one on top of the other, are present in a mixed state in a boundary layer. In other words, diffusion has taken place by means of a special method of connecting the two connecting portions in the boundary layer that is embodied on the contacting surface area of the surfaces.

The term ‘a terminal’ is understood to mean in this case the part of a battery cell that is electrically conductively connected in the battery cell body to an electrode and protrudes with a portion, the so-called battery pole, out of the battery cell body.

### ADVANTAGES OF THE INVENTION

Thus, as a result of mixing particulate materials of the connecting portions that lie one on top of the other in the boundary layer, there is no gap into which condensation fluid can penetrate. In other words, only a minimum surface area, namely the outer region or edge region of the boundary layer, can be attacked by corrosion as a result of condensation. Thus, corrosion between the two surfaces is prevented and consequently the serviceable life of the connector is considerably increased and the transition resistance, in particular in the case of older connectors, is considerably reduced and the functional reliability ensured over a longer period of time.

Advantageously, the particulate materials on the surfaces are mixed in such a manner that the connecting portions in the connecting region form a composite material. In other words, the connector comprises in the connecting region a material embodied from the two mutually connected materials. The connection is achieved by means of a material closure and/or a positive closure.

Preferably, said particulate materials are mixed by means of plating. In other words, said particulate materials are mixed by means of a method in which a more base metal is covered by a different more noble metal. As a consequence, a non-releasable connection can be produced between the two materials. This can, for example, be achieved by rolling metal films or metal strips, also by welding and in particular by laser welding, ultrasound welding or friction welding. In accordance with the invention, all welding methods can be used in which a large surface area connection can be achieved between the surfaces. Alternatively, the plating can also be achieved by soldering, coating (ion plating), dipping, explosive plating or by means of a galvanic method, such as electro-plating.

It is provided in a particularly preferred embodiment that said particulate materials are mixed by means of cold-roll plating and a first connecting portion is embodied from a copper material and a second connecting portion is embodied from an aluminum material. During the cold-roll plating process, two layers are pressed one against the other under the influence of a heavy pressure, such as rolling, wherein, depending upon the amount of the pressure, heat is produced that enhances the diffusion of the particulate materials on the connecting surfaces in order to generate the boundary layer. Alternatively, said materials can also be subjected to a hot-roll plating process.

Bronze materials or brass materials can be used as useable copper materials. Further alternative useable materials are nickel, steel, cobalt and silver and/or alloys thereof that can be mutually combined in accordance with the invention or can be combined with a said aluminum material or a said copper material in the connector in accordance with the invention.

In particular, it is possible for the first connecting portion to be embodied from a copper material E-Cu57 or E-Cu58.

In this case, the second connecting portion should be embodied preferably from Al6061 or Al3303 H14. However, in this case, the use of other copper materials or aluminum materials in dependence upon the plating method being used is not excluded.

A further aspect of the present invention is thus a method for producing the connector in accordance with the invention, in which method the connecting portions are mutually connected in an electrically conductive manner by means of cold-roll plating.

In addition, the present invention comprises a battery, in particular a lithium-ion battery or a nickel metal-hydride battery, that comprises in each case a plurality of battery cells and at least one connector in accordance with the invention, wherein the connector connects a terminal of a first battery cell of the battery to a terminal of a second battery cell of the battery. In so doing, the term ‘a terminal’ is understood to mean the respective cathode or anode that outside the battery cell embodies the respective minus pole or positive pole. The connector in accordance with the invention is thus used to produce a connection between the battery cells, preferably a series connection. Conventionally, in this case, a pole of a battery cell, advantageously the minus pole, is embodied from a copper material and the positive pole is embodied from an aluminum material. Thus, the connector in accordance with the invention can be connected on its face that comprises copper to the minus pole of a first battery cell and to the positive pole of a second battery cell. The advantage resides in the fact that in each case similar materials or materials comprising at least the same base material are connected, which can be achieved in a technically simpler and more cost-effective manner than connecting different materials.

A further aspect of the present invention is a battery system that comprises a plurality of batteries, in particular lithium-ion batteries or nickel metal-hydride batteries and at least one connector in accordance with the invention, wherein the connector connects a terminal of a first battery to a terminal of a second battery. Thus, it is possible by means of the connector in accordance with the invention to mutually connect a plurality of batteries using connecting technology. In a further embodiment, one or a plurality of further connectors in accordance with the invention is used in order to mutually connect individual battery cells inside the mutually connected batteries. In other words, the connector in accordance with the invention cannot only be used to connect battery cells in a battery, but it can also be used to connect and link a plurality of batteries using switching technology.

The invention also relates to a motor vehicle, in particular a motor vehicle that can be driven by an electric motor, which motor vehicle comprises at least one battery in accordance with the invention or a battery system in accordance with the invention, wherein the battery is connected to a drive system of the motor vehicle.

### DRAWINGS

Exemplary embodiments of the invention are explained in detail with reference to the drawing and the description hereinunder. In the drawing:

FIG. 1 shows a connector in accordance with the invention.

FIG. 1 illustrates a connector 1 in accordance with the invention that comprises a first connecting portion and a second connecting portion 12. The two connecting portions 11, 12 form an overlap that defines the connecting region 16. The connection of the two connecting portions 11, 12 in the connecting region 16 is achieved by means of placing the first surface 13 of the first connecting portion 11 on the second surface 14 of the second connecting portion 12.

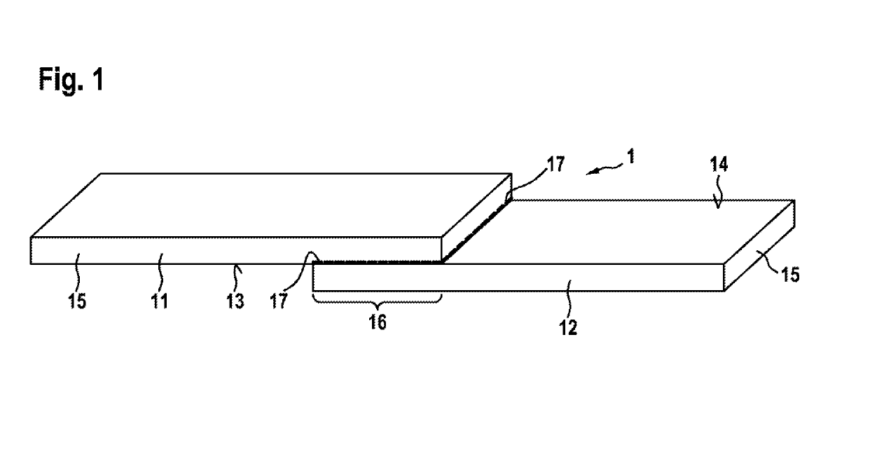

The connector 1 is embodied in the connecting region 16 as a composite material. The particulate materials of the surfaces 13, 14 are present in a mixed and/or diffused state in the boundary layer 17 that is present in the connecting region 16 on the first surface 13 and on the second surface 14. As already mentioned, said particulate materials can be mixed in this manner, for example, by plating, in particular roll plating. In other words, the material present in the boundary layer 17 is not the material of the first connecting portion 11 or of the second connecting portion 12 but rather a material that comprises a mixture of the particulate materials of the first connecting portion 11 and of the second connecting portion 12. As a consequence, the two connecting portions 11, 12 are mutually fixed.

The ends of the respective connecting portions 11, 12, which ends lie opposite the connecting region 16, comprise the fastening faces 15. The connector 1 is to be mounted at these fastening faces 15 on the terminals and/or on the poles of the respective battery cells or batteries, in order thus to provide an electrically conductive connection between the battery terminals and/or poles.

A high level of conductivity of the connection between the individual materials of the first connecting portion 11 and of the second connecting portion 12, that can be embodied, for example, from a material that comprises copper and from a material that comprises aluminum, can be produced by virtue of mixing the particulate materials of the surfaces 13, 14, such as by means of cold-roll plating. There is no gap between the surfaces 13, 14, so that any surface area and/or region that can be attacked by corrosion on the outer face of the boundary layer 17 is reduced at the edges of the connecting portions 11, 12. Any water that is produced in battery systems as a result of condensation is thus unable to pass between the connecting portions 11, 12 and cannot cause any gap corrosion at this site.

The edge of the boundary layer 17 can be provided with a suitable insulation to prevent corrosion on this boundary layer. An insulation of this type prevents any wetting of the edge region of the boundary layer 17 by condensation water, so that the condensation water cannot provide a connection of the materials of the first connecting portion 11 and of the second connecting portion 12. An insulation of this type can, in addition to being a suitable coating and/or lacquering, be a shrinkable tubing that covers the edge region of the boundary layer 17.

The connector 1 in accordance with the invention can be embodied in such a manner that the first connecting portion 11 is manufactured from the material that comprises copper and the second connecting portion 12 is manufactured from the material that comprises aluminum. Advantageously, the first connecting portion 11 is then shorter than the second connecting portion 12 in order to reduce the portion of the more cost-intensive material that comprises copper on the connector 1. For this purpose, the connecting region 16 can be arranged in the proximity of the battery cell terminal and/or pole, to which the first connecting portion 11 is connected. In a particular embodiment, the first connecting portion 11 that comprises copper is connected in the battery cell to the terminal thereof, which provides the advantage that outside the battery cell and in order to mount the individual cells only one connection in each case, namely the connection to the battery cell to be connected, is to be achieved. In addition to simplifying the assembly steps that are to be performed, there is the technological advantage that merely only one connecting process is to be performed, in which connecting process essentially identical materials are connected, since in this case merely only the second connecting portion 12 that comprises aluminum is to be connected to the aluminum terminal of the second battery cell.

1. A connector for producing an electrically conductive connection between battery cell terminals to electrically link battery cells, comprising:
at least two connecting portions, wherein:
each of the at least two connecting portions comprises a different material,
each of the at least two connecting portions has a contacting surface,
the at least two connecting portions are mutually connected in an electrically conductive manner in at least one connecting region by the contacting surfaces,
the contacting surfaces lie on top of one another, and
particulate materials of the contacting surfaces of the at least two connecting portions are in a mixed state in a boundary layer.

2. The connector as claimed in claim 1, wherein said particulate materials are mixed such that the at least two connecting portions in the connecting region form a composite material.

3. The connector as claimed in claim 1, wherein said particulate materials are mixed by plating.

4. The connector as claimed in claim 3, wherein:
said particulate materials are mixed by cold-roll plating, and
a first connecting portion is formed from a copper material and a second connecting portion is formed from an aluminum material.

5. The connector as claimed in claim 4, wherein the first connecting portion is formed from E-Cu57 or E-Cu58.

6. The connector as claimed in claim 4, wherein the second connecting portion is formed from Al6061 or Al3003 H14.

7. A method for producing a connector which provides an electrically conductive connection between battery cell terminals to electrically link battery cells, comprising:
mutually connecting at least two connecting portions in an electrically conductive manner by cold-roll plating, wherein:
each of the at least two connecting portions comprises a different material,
each of the at least two connecting portions has a contacting surface,
the at least two connecting portions are mutually connected in an electrically conductive manner in at least one connecting region by the contacting surfaces,
the contacting surfaces lie on top of one another, and
particulate materials of the contacting surfaces of the at least two connecting portions are in a mixed state in a boundary layer.

8. A battery, comprising:
a plurality of battery cells including a first battery cell and a second battery cell; and
at least one connector configured to produce an electrically conductive connection between battery cell terminals to electrically link battery cells, the at least one connector including:
at least two connecting portions, wherein:
each of the at least two connecting portions comprises a different material,
each of the at least two connecting portions has a contacting surface
the at least two connecting portions are mutually connected in an electrically conductive manner in at least one connecting region by the contacting surfaces,
the contacting surfaces lie on top of one another,
particulate materials of the contacting surfaces of the at least two connecting portions are in a mixed state in a boundary layer, and
the at least one connector connects a terminal of the first battery cell to a terminal of the second battery cell.

9. A battery system, comprising:
a plurality of batteries including a first battery and a second battery; and
at least one connector configured to produce an electrically conductive connection between battery cell terminals to electrically link battery cells, the at least one connector including:
at least two connecting portions, wherein:
the battery cells includes a first battery cell and a second battery cell,
each of the at least two connecting portions comprises a different material,
each of the at least two connecting portions has a contacting surface
the at least two connecting portions are mutually connected in an electrically conductive manner in at least one connecting region by the contacting surfaces,
the contacting surfaces lie on top of one another,
particulate materials of the contacting surfaces of the at least two connecting portions are in a mixed state in a boundary layer, and
the at least one connector connects at least one of a terminal of the first battery to a terminal of the second battery; and a terminal of the first battery cell to a terminal of the second battery cell.

10. A motor vehicle, comprising:
at least one battery as claimed in claim 8, wherein the at least one battery is connected to a drive system of the motor vehicle.
